(19) United States
(12) Patent Application Publication
(10) Pub. No.: US 2018/0047186 A1
(43) Pub. Date: Feb. 15, 2018

(54) IMAGE PROCESSING METHOD FOR CORRECTING DARK CIRCLE UNDER HUMAN EYE

(71) Applicant: CASIO COMPUTER CO., LTD., Tokyo (JP)

(72) Inventor: Takeshi Sato, Tokyo (JP)

(21) Appl. No.: 15/671,933

(22) Filed: Aug. 8, 2017

(30) Foreign Application Priority Data
Aug. 10, 2016 (JP) 2016-157491

(51) Int. Cl. G06T 11/00; G06T 11/60

(52) U.S. Cl. CPC G06T 11/001; G06T 11/60

(57) ABSTRACT

An image capture apparatus includes a pupil detection unit, a dark circle correction map generation unit, and an image composition unit. The image capture apparatus corrects a dark circle in an image. The pupil detection unit detects the human eye in the image. The dark circle correction map generation unit generates correction information indicating a position for correction in the image and a correction magnitude by acquiring color information about the dark circle and reference skin color information in the image based on the position of the human eye in the image detected by the pupil detection unit. The image composition unit executes processing of correcting the dark circle in the image by using the correction information generated by the dark circle correction map generation unit.

### CROSS-REFERENCE TO RELATED APPLICATION

This application is based on and claims the benefit of priority from Japanese Patent Application No. 2016-157491, filed on 10 Aug. 2016, the content of which is incorporated herein by reference.

### BACKGROUND OF THE INVENTION

### Field of the Invention

The present invention relates to an image processing method and an image processing apparatus.

### Related Art

Processing of correcting dark circles under eye has conventionally been executed as part of processing for better aesthetic outcomes of image processing. According to a simple image processing method relating to such a technique, a human eye is detected, and a portion under the detected eye is blurred or the color value of this portion is increased, for example. However, such processing has caused a problem of failing to correct dark circles appropriately that are to be changed in their positions or levels of darkness by individual differences or conditions of image capture, for example. This problem may be solved by a technique disclosed by patent document 1, Japanese Patent Application Publication No. 2002-200050, for example. This technique is to correct a dark circle appropriately by measuring a pigment component precisely such as a melanin component or a hemoglobin component to contribute to a skin color.

### SUMMARY OF THE INVENTION

An image processing method according to one aspect of the present invention is a method for correcting a dark circle in an image, the method comprising: detection processing of detecting a human eye in the image; correction information generation processing of generating correction information indicating a position for correction in the image and a correction magnitude, by acquiring color information about the dark circle and reference skin color information in the image based on the position of the human eye in the image detected by the detection processing; and image processing of executing processing of correcting the dark circle in the image by using the correction information generated by the correction information generation processing.

An image processing method according to one aspect of the present invention is a method for correcting a dark circle in an image, the method comprising: correction information generation processing of generating correction information based on color information in HSV color space, to be used for correcting the dark circle in the image, and wherein the correction information indicates a position for correction in the image and a correction magnitude; and image processing of executing processing of correcting the dark circle in the image based on color information in YUV color space by using the correction information generated by the correction information generation processing.

An image processing method according to one aspect of the present invention is a method for correcting a dark circle in an image, the method comprising: candidate region designation processing of designating a candidate region for a dark circle region in the image based on color information acquired from the image; dark circle region designation processing of designating the dark circle region in the image by correcting position information in an image of the candidate region designated by the candidate region designation processing while using reference dark circle region information prepared in advance containing position information in the image; and image processing of executing processing of correcting the color of the dark circle region designated by the dark circle region designation processing.

An image processing apparatus according to one aspect of the present invention is an apparatus for correcting a dark circle in an image, the apparatus comprising a processor that is configured to: detect the human eye in the image; generate correction information indicating a position for correction in the image and a correction magnitude by acquiring color information about the dark circle and reference skin color information in the image based on the position of the detected human eye in the image; and execute processing of correcting the dark circle in the image by using the generated correction information.

An image processing apparatus according to one aspect of the present invention is an apparatus for correcting a dark circle in an image, the apparatus comprising a processor that is configured to: generate correction information based on color information in HSV color space, to be used for correcting the dark circle in the image, and wherein the correction information indicates a position for correction in the image and a correction magnitude; and execute processing of correcting the dark circle in the image based on color information in YUV color space by using the generated correction information.

An image processing apparatus according to one aspect of the present invention is an apparatus for correcting a dark circle in an image, the apparatus comprising a processor that is configured to: designate a candidate region for a dark circle region in the image based on color information acquired from the image; designate the dark circle region in the image by correcting position information in an image of the designated candidate region while using reference dark circle region information prepared in advance containing position information in the image; and execute processing of correcting the color of the designated dark circle region.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

This application will be understood more deeply by considering the detailed description given below and the drawings explained below.

FIG. 1 is a block diagram showing the hardware configuration of an image capture apparatus 1 as an embodiment of an image processing apparatus according to the present invention;

FIG. 2 is a schematic view for explaining generation of a dark circle corrected image according to the present embodiment;

FIG. 3 is a schematic view for explaining generation of a dark circle correction map;

FIGS. 4A to 4C are schematic views for explaining generation of a hue map;

FIG. 5 is a schematic view for explaining generation of a fixed map;

FIG. 6 is a functional block diagram showing a functional configuration belonging to the functional configuration of the image capture apparatus 1 in FIG. 1 and responsible for execution of dark circle corrected image generation processing;

FIG. 7 is a flowchart explaining a flow of the dark circle corrected image generation processing executed by the image capture apparatus 1 in FIG. 1 having the functional configuration in FIG. 6;

FIG. 8 is a flowchart explaining a flow of dark circle correction processing as part of the dark circle corrected image generation processing; and

FIG. 9 is a flowchart explaining a flow of dark circle correction map generation processing as part of the dark circle corrected image generation processing.

### DETAILED DESCRIPTION OF THE INVENTION

An embodiment of the present invention will be described below by using the drawings.

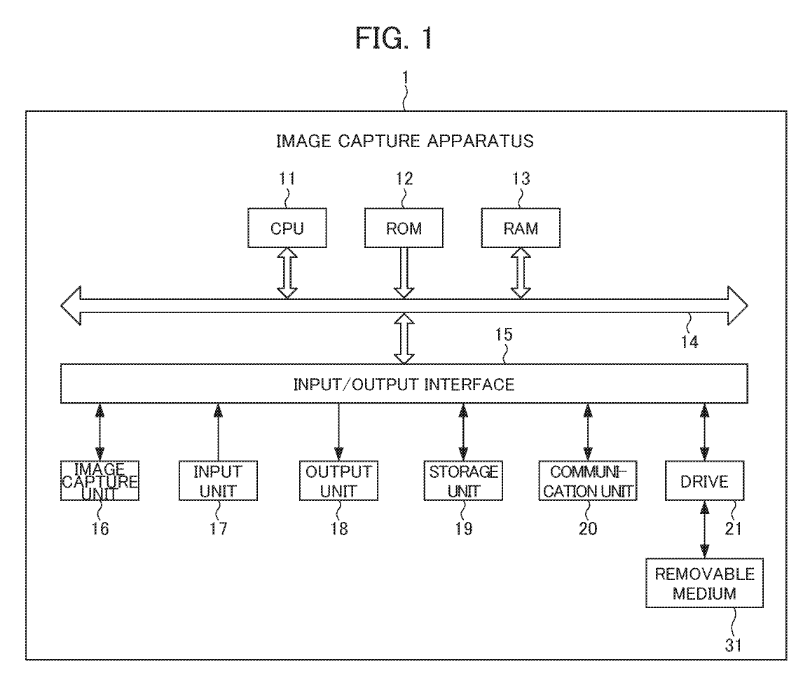

FIG. 1 is a block diagram showing the hardware configuration of an image capture apparatus 1 as an embodiment of an image processing apparatus according to the present invention. The image capture apparatus 1 is configured as, for example, a digital camera.

The image capture apparatus 1 includes a CPU (Central Processing Unit) 11, ROM (Read Only Memory) 12, RAM (Random Access Memory) 13, a bus 14, an input/output interface 15, an image capture unit 16, an input unit 17, an output unit 18, a storage unit 19, a communication unit 20, and a drive 21.

The CPU 11 executes various processing according to programs that are recorded in the ROM 12, or programs that are loaded from the storage unit 20 to the RAM 13.

The RAM 13 also stores data and the like necessary for the CPU 11 to execute the various processing, as appropriate.

The CPU 11, the ROM 12 and the RAM 13 are connected to one another via the bus 14. The input/output interface 15 is also connected to the bus 14. The image capture unit 16, the input unit 17, the output unit 18, the storage unit 19, the communication unit 20, and the drive 21 are connected to the input/output interface 15.

The image capture unit 16 includes an optical lens unit and an image sensor, which are not illustrated.

In order to photograph a subject, the optical lens unit is configured by a lens such as a focus lens and a zoom lens for condensing light. The focus lens is a lens for forming an image of a subject on the light receiving surface of the image sensor. The zoom lens is a lens that causes the focal length to freely change in a certain range. The optical lens unit also includes peripheral circuits to adjust setting parameters such as focus, exposure, white balance, and the like, as necessary.

The image sensor is configured by an optoelectronic conversion device, an AFE (Analog Front End), and the like. The optoelectronic conversion device is configured by a CMOS (Complementary Metal Oxide Semiconductor) type of optoelectronic conversion device and the like, for example. Light incident through the optical lens unit forms an image of a subject in the optoelectronic conversion device. The optoelectronic conversion device optoelectronically converts (i.e. captures) the image of the subject, accumulates the resultant image signal for a predetermined time interval, and sequentially supplies the image signal as an analog signal to the AFE. The AFE executes a variety of signal processing such as A/D (Analog/Digital) conversion processing of the analog signal. The variety of signal processing generates a digital signal in YUV color space that is output as an output signal from the image capture unit 16. Such an output signal of the image capture unit 16 is hereinafter referred to as “data of a captured image”. Data of a captured image is supplied to the CPU 11, an image processing unit (not illustrated), and the like as appropriate.

The input unit 17 is configured by various buttons and the like, and inputs a variety of information in accordance with instruction operations by the user. The output unit 18 is configured by the display unit, a speaker, and the like, and outputs images and sound. The storage unit 19 is configured by DRAM (Dynamic Random Access Memory) or the like, and stores data of various images. The communication unit 20 controls communication with other devices (not shown) via networks including the Internet.

A removable medium 31 composed of a magnetic disk, an optical disk, a magneto-optical disk, semiconductor memory or the like is installed in the drive 21, as appropriate. Programs that are read via the drive 21 from the removable medium 31 are installed in the storage unit 19, as necessary. Similarly to the storage unit 19, the removable medium 31 can also store a variety of data such as the image data stored in the storage unit 19.

The image capture apparatus 1 with the above-described configuration has a function that allows generation of an image by removing only a dark circle in a face from a captured image of the face.

[Generation of Dark Circle Corrected Image]

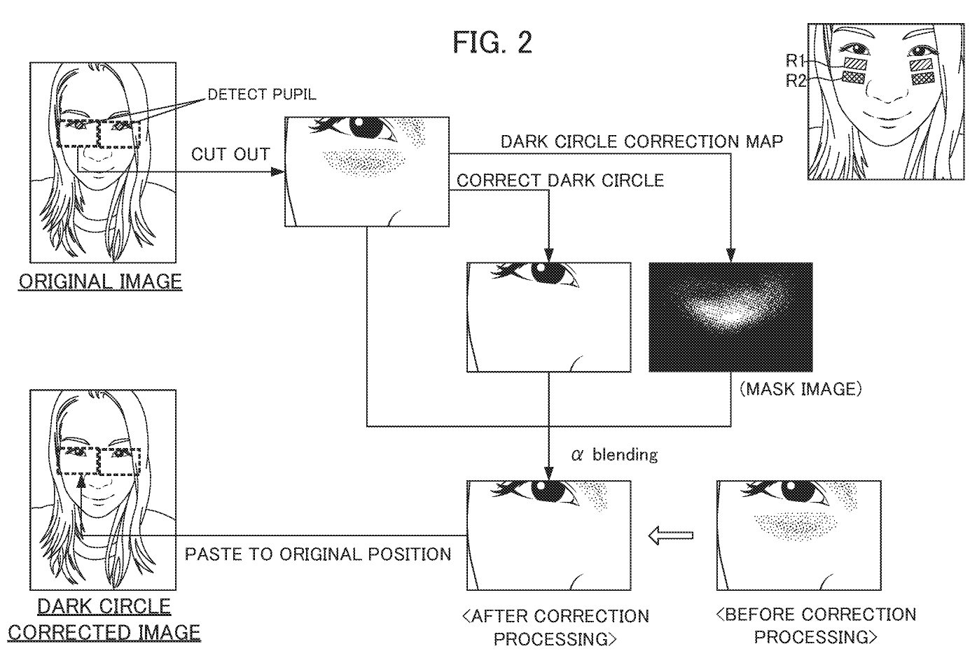

Generation of a dark circle corrected image will be described. FIG. 2 is a schematic view for explaining generation of a dark circle corrected image according to the present embodiment.

As shown in FIG. 2, to generate a dark circle corrected image according to the present embodiment, an original image is analyzed first to detect the position of the pupil of human eye. To conform to a predetermined standard, a processing target region is cut out in a manner that depends on the detected positions of the right and left pupils relative to each other.

Dark circle correction of removing a dark circle is made on the cutout image entirely. The dark circle correction is to correct the color of a region (hereinafter called a “dark circle color region”) R1 in a face where a dark circle is assumed to be present so as to approximate the color of the dark circle color region R1 to the color of a skin region (hereinafter called a “reference skin color region”) R2 assumed to be a reference region of the face.

Generation of a dark circle corrected image according to the present embodiment includes generation of a map (hereinafter called a “dark circle correction map”) indicating a dark circle position and a correction magnitude. According to the present embodiment, the dark circle correction map indicates a region as a target of dark circle correction and indicates a correction magnitude. The dark circle correction map functions as a mask image to become an a value during image composition by means of α blending.

Next, an image resulting from dark circle correction is combined on the cutout image by means of α blending using the mask image indicating the a value with the dark circle correction map.

Finally, the composite image is pasted to a position in the original image where the cutout image was originally present, thereby generating a dark circle corrected image from which only a dark circle portion in the face is removed. FIG. 2 illustrates correction of a dark circle around the left eye. A dark circle around the right eye is corrected in the same manner.

[Method of Dark Circle Correction]

Dark circle correction will be described in detail below. For dark circle correction, a mode of Y, a mode of U, and a mode of V in YUV color space are measured for the dark circle color region R1. Further, a mode of Y, a mode of U, and a mode of V in YUV color space are measured for the reference skin color region R2. In the below, a mode of Y, a mode of U, and a mode of V for the dark circle color region R1 will be called Ya, Ua, and Va respectively. A mode of Y, a mode of U, and a mode of V for the reference skin color region R2 will be called Yb, Ub, and Vb respectively. To conform to a standard determined in advance based on the size of a face or the positions of pupils, the dark circle color region R1 and the reference skin color region R2 are set at their positions differing between the right and left pupils and are set to have the same area.

For dark circle correction, an entire image is corrected in terms of each of a Y channel, a U channel, and a V channel. In order to make a boundary between a corrected region and an uncorrected region indistinctive, correction of the Y channel is made so as to approximate Ya to Yb. Gamma (LUT: look-up table) is used for this correction. Correction of the U channel and that of the V channel are made so as to approximate Ua to Ub and to approximate Va to Vb. Shift processing is used for these corrections. The shift processing uses the following formulas (1) and (2):

Shift amount of U=Ub−Ua (1)

Shift amount of V=Vb−Va (2)

According to the present embodiment, on condition that the boundary be indistinctive, gamma correction is used for the Y channel as the Y channel is to be sensed sensitively by a person, even if using gamma correction might increase processing burden. Meanwhile, shift processing that can be executed easily is used for U and V as U and V are not to be sensed sensitively.

[Generation of Dark Circle Correction Map]

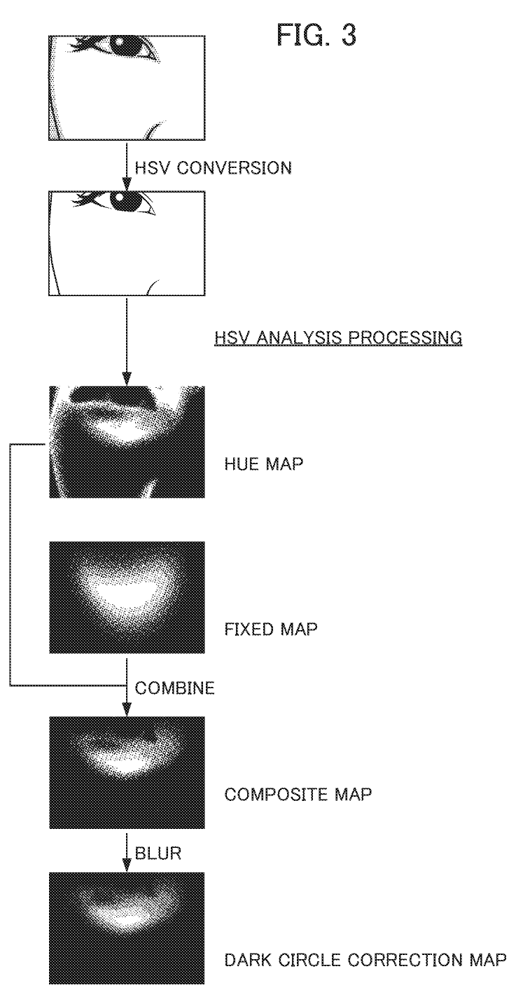

Generation of the dark circle correction map will be described in detail next. FIG. 3 is a schematic view for explaining generation of the dark circle correction map.

As shown in FIG. 3, for generation of the dark circle correction map, the cutout image in YUV color space is converted to HSV (hue, saturation (or chroma), and value (or lightness or brightness)) color space. Next, the HSV-converted cutout image is analyzed. Each pixel is weighted in terms of each of an H channel, an S channel, and a V channel with a value calculated based on a result of the analysis to generate a hue map. A skin-colored and relatively dark region is designated in a face by using the hue map. Then, a fixed map generated in advance to be arranged at a position relative to a pupil and resembling the shape of a dark circle is combined with the generated hue map to generate a composite map. For generation of the composite map, a minimum of the hue map and that of the fixed map are employed and a region not to be subjected to dark circle correction is cut. Then, the composite map is blurred to be smoothened to generate the dark circle correction map. This blurring may be omitted.

[Generation of Hue Map]

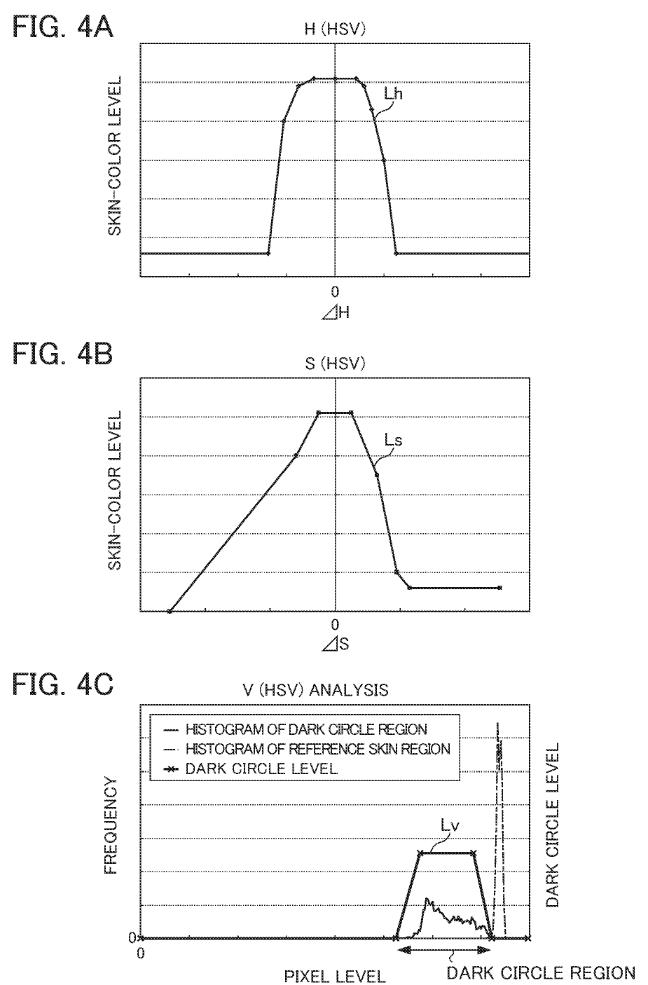

Generation of the hue map will be described in detail next. FIGS. 4A to 4C are schematic views for explaining generation of the hue map.

The hue map is used for designating a skin-colored and relatively dark region in a face. The hue map contains a hue map value of each pixel obtained by calculating dark circle levels indicating the respective intensities of dark circles of the H channel, the S channel, and the V channel, and by multiplying the calculated levels. Specifically, the hue map value is expressed by the following formula (3):

Hue map value: Map=Lh×Ls×Lv (3)

In this formula, “Lh” means the dark circle level of the H channel, “Ls” means the dark circle level of the S channel, and “Lv” means the dark circle level of the V channel.

The dark circle level of the H channel is determined by calculating an average of the H channels in the dark circle color region R1 and obtaining a difference from the average calculated for each pixel. FIG. 4A shows an example of the dark circle level responsive to the difference from the average. The dark circle level is reduced with increase in the difference from the average. Specifically, a dark circle is weakened with increase in this difference.

The dark circle level of the S channel is determined by calculating an average of the S channels in the dark circle color region R1 and obtaining a difference from the average calculated for each pixel. FIG. 4B shows an example of the dark circle level responsive to the difference from the average. The dark circle level is reduced with increase in the difference from the average. Specifically, a dark circle is weakened with increase in this difference.

Meanwhile, the dark circle level of the V channel is determined by analyzing a histogram of the V channel in each of the dark circle color region R1 and the reference skin color region R2 and calculating a level assumed to be the level of a dark circle region. As shown in the example of FIG. 4C, the dark circle level of the V channel is set in a range corresponding to the dark circle color region R1 so as to smoothen the boundary, in a manner that depends on a mode in the dark circle color region R1 and a mode in the reference skin color region R2. Specifically, the dark circle level of the V channel is calculated in a manner that depends on a color value (pixel level of the V channel) and the frequency of the color value in each of the dark circle color region R1 and a color value in the reference skin color region R2.

[Generation of Fixed Map]

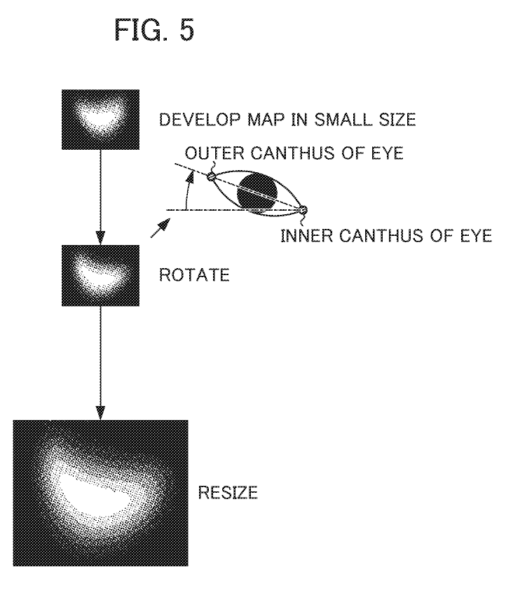

Generation of a fixed map will be described in detail. FIG. 5 is a schematic view for explaining generation of the fixed map.

The fixed map shows an imitative position of a dark circle relative to that of a pupil, an imitative shape of the dark circle relative to that of the pupil, or an imitative shape of the dark circle in a general face. The fixed map is generated in advance in preparation for dark circle correction. As shown in FIG. 5, the fixed map is developed from data as a map in a small size. Then, as shown in FIG. 5, an tilt angle of an eye is calculated by using contour information about the eye in an image (such as the inner canthus or the outer canthus of the eye), and the fixed map is rotated to conform to the calculated angle. Finally, the size of the fixed map is changed to conform to the size of the image to be available for use.

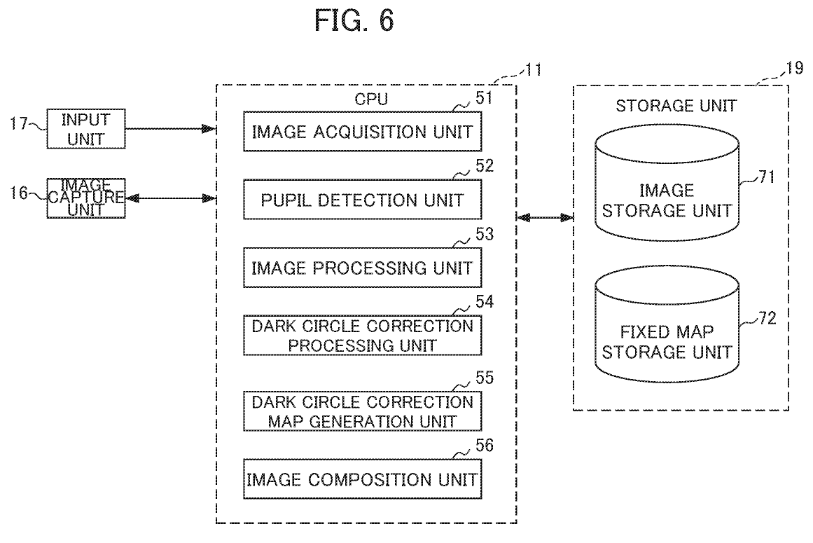

FIG. 6 is a functional block diagram showing a functional configuration belonging to the functional configuration of the image capture apparatus 1 in FIG. 1 and responsible for execution of dark circle corrected image generation processing. The dark circle corrected image generation processing is a processing sequence of generating a dark circle corrected image including designating a dark circle region in a captured image of a human face and removing a dark circle.

As shown in FIG. 6, for execution of the dark circle corrected image generation processing, the following units become functional in the CPU 11: an image acquisition unit 51, a pupil detection unit 52, an image processing unit 53, a dark circle correction processing unit 54, a dark circle correction map generation unit 55, and an image composition unit 56.

An image storage unit 71 and a fixed map storage unit 72 are defined in a partial region of the storage unit 19. The image storage unit 71 stores data about a captured image of a human face. The fixed map storage unit 72 stores data about a fixed map such as that shown in FIG. 5.

The image acquisition unit 51 acquires an image of a processing target. More specifically, the image acquisition unit 51 acquires an image output from the image capture unit 16 as a processing target, for example.

The pupil detection unit 52 detects a pupil in the image acquired by the image acquisition unit 51. According to the present embodiment, a pupil is detected by using an existing image analysis technique.

The image processing unit 53 executes image processing such as cut and paste of an image. As a specific example, the image processing unit 53 cuts out an image from an original image and pastes the cutout image to a position in the original image where the cutout image was originally present.

The dark circle correction processing unit 54 executes dark circle correction processing. The dark circle correction processing unit 54 executes the dark circle correction processing on an image cut out by the image processing unit 53. As a result of the dark circle correction processing, the cutout image is entirely corrected to such an extent as to remove a dark circle.

The dark circle correction map generation unit 55 executes dark circle correction map generation processing. A dark circle correction map is generated as a result of the dark circle correction map generation processing.

The image composition unit 56 combines images. As a specific example, the image composition unit 56 combines an image resulting from dark circle correction on the cutout image by means of α blending using the mask image indicating the a value with the dark circle correction map.

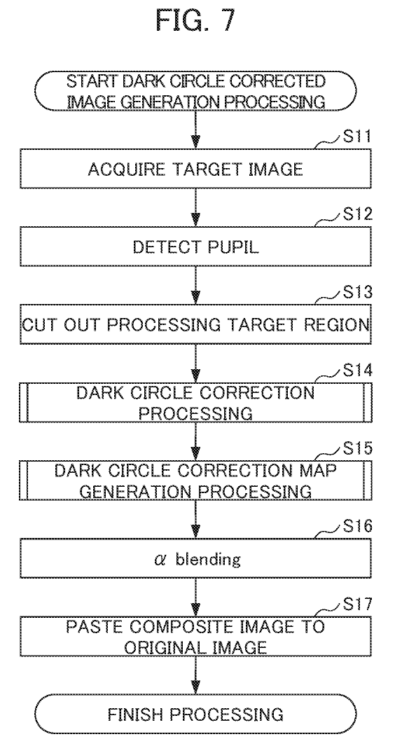

FIG. 7 is a flowchart explaining a flow of the dark circle corrected image generation processing executed by the image capture apparatus 1 in FIG. 1 having the functional configuration in FIG. 6. The dark circle corrected image generation processing starts in response to user's operation on the input unit 17 for starting the dark circle corrected image generation processing.

In step S11, the image acquisition unit 51 acquires an image output from the image capture unit 16 as a processing target image.

In step S12, the pupil detection unit 52 detects a pupil in the image acquired by the image acquisition unit 51.

In step S13, the image processing unit 53 cuts out a processing target region in a manner that depends on the pupil position in the image detected by the pupil detection unit 52. An example of the cutout image is shown in FIG. 2.

In step S14, the dark circle correction processing unit 54 executes the dark circle correction processing on the image cut out by the image processing unit 53. As a result of the dark circle correction processing, the cutout image is entirely corrected to such an extent as to remove a dark circle, as shown in FIG. 2. A flow of the dark circle correction processing will be described in detail later.

In step S15, the dark circle correction map generation unit 55 executes the dark circle correction map generation processing. As a result of the dark circle correction map generation processing, a dark circle correction map such as that shown in FIGS. 2 and 3 is generated.

In step S16, the image composition unit 56 combines an image resulting from dark circle correction on the cutout image by means of α blending using the mask image indicating the a value with the dark circle correction map. As shown in FIG. 2, a position where a dark circle was present is replaced by the cutout image without the dark circle.

In step S17, the image processing unit 53 pastes a composite image generated by the image composition unit 56 to a position (original position) in an original image where the cutout image was originally present. As a result, a dark circle corrected image such as that shown in FIG. 2 is generated. Then, the dark circle corrected image generation processing is finished.

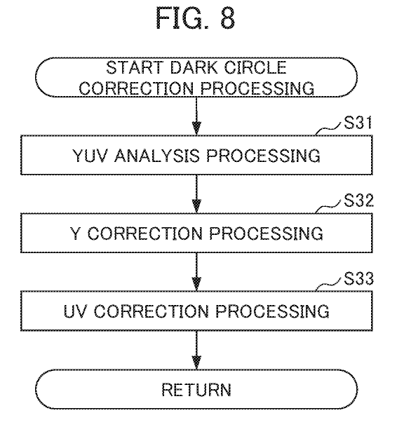

FIG. 8 is a flowchart explaining a flow of the dark circle correction processing as part of the dark circle corrected image generation processing.

In step S31, the dark circle correction processing unit 54 executes YUV analysis processing in YUV color space by measuring respective modes of Y, U, and V (Ya, Ua, and Va) for the dark circle color region R1 and by measuring respective modes of Y, U, and V (Yb, Ub, and Vb) for the reference skin color region R2.

In step S32, the dark circle correction processing unit 54 executes Y correction processing of making gamma correction so as to approximate Ya to Yb.

In step S33, the dark circle correction processing unit 54 executes UV correction processing by executing shift processing so as to approximate Ua to Ub and to approximate Va to Vb. According to the present embodiment, a shift amount of U and a shift amount of V for this shift processing are obtained from the above-described formulas (1) and (2) respectively. As a result of this dark circle correction processing, the image cut out by the image processing unit 53 is corrected entirely. Thus, a region other than the dark circle region is also corrected.

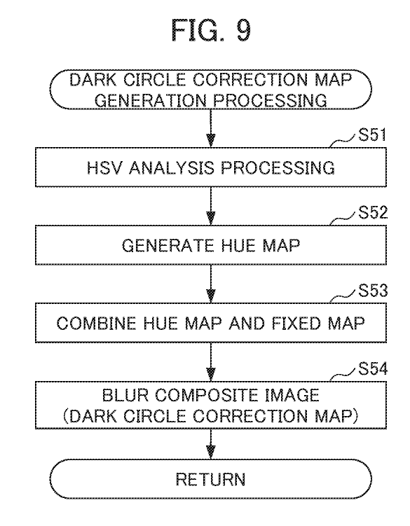

FIG. 9 is a flowchart showing a flow of the dark circle correction map generation processing as part of the dark circle corrected image generation processing.

In step S51, the dark circle correction map generation unit 55 executes HSV analysis processing. For the HSV analysis processing, the cutout image in YUV color space is converted first to HSV. Then, a histogram of the V channel in each of the dark circle color region R1 and the reference skin color region R2 is generated. Further, an average of the H channels and an average of the S channels are calculated. As a result, as shown in FIGS. 4A to 4C, the respective dark circle levels (Lh, Ls, and Lv) of H, S, and V become settable for each pixel.

In step S52, the dark circle correction map generation unit 55 multiplies the respective dark circle levels (Lh, Ls, and Lv) of H, S, and V for each pixel to calculate a hue map value, thereby generating a hue map such as that shown in FIG. 3.

In step S53, the dark circle correction map generation unit 55 combines the generated hue map and the fixed map stored in the fixed map storage unit 72. For the composition, the size and the angle of the fixed map are adjusted, as shown in FIG. 5.

In step S54, the dark circle correction map generation unit 55 blurs the composite map to generate the dark circle correction map. The generated dark circle correction map indicates a dark circle region in the image cut out by the image processing unit 53. As a result of execution of a blending using the image subjected entirely to the dark circle correction processing, an image subjected to the dark circle correction processing executed only on its dark circle region can be generated.

Many existing techniques for dark circle correction are merely to brighten regions under eye by blurring these regions. By contrast, the technique for dark circle correction according to the present embodiment is to extract a dark circle region from a face region by using a result of detection of a pupil in a captured image of a human and to make optimum correction so as to alleviate a dark circle. The dark circle region is extracted by analyzing an HSV image about each of right and left eyes and generating the dark circle correction map using the analyzed HSV image. For the correction, a YUV image is analyzed and the analyzed image is corrected in terms of each of the Y, U, and V channels. For extraction of the dark circle region, two regions including the dark circle color region R1 and the reference skin color region R2 are measured by using the result of detection of the pupil. Then, HSV in each of the two regions including the dark circle color region R1 and the reference skin color region R2 is analyzed to determine “only a dark skin color region under an eye.”

Gamma (LUT: look-up table) correction is made for dark circle correction in terms of the Y channel to make a boundary between a corrected region and an uncorrected region indistinctive. As a result, only a dark circle region in a face can be corrected optimally so as to make a dark circle indistinctive without blurring an image.

The image capture apparatus 1 having the above-described configuration includes the pupil detection unit 52, the dark circle correction map generation unit 55, and the image composition unit 56. The image capture apparatus 1 corrects a dark circle under a human eye in an image. The pupil detection unit 52 detects the human eye including a human pupil or the human pupil in the image. The dark circle correction map generation unit 55 generates correction information (dark circle correction map) indicating a position for correction in the image and a correction magnitude by acquiring color information about the dark circle and reference skin color information in the image based on the position of the human eye or that of the human pupil in the image detected by the pupil detection unit 52. The image composition unit 56 executes processing of correcting the dark circle under the human eye in the image by using the correction information (dark circle correction map) generated by the dark circle correction map generation unit 55. As described above, the image capture apparatus 1 detects the position of the pupil in the image, designates predetermined positions below the position of the detected pupil as a dark circle color region and a reference skin color region, and generates a mask based on color information acquired from each of the dark circle color region and the reference skin color region. Thus, the image capture apparatus 1 is allowed to generate appropriate correction information and correct a dark circle based on color information about the dark circle and skin color information appropriately responsive to individual differences or conditions of image capture. As a result, the image capture apparatus 1 is allowed to correct the dark circle under the human eye appropriately by using the simple method.

The dark circle correction map generation unit 55 designates positions below the position of the detected human eye or that of the detected human pupil in the image as a position in the image where the color information about the dark circle is to be acquired and as a position in the image where the reference skin color information is to be acquired, and acquires the color information about the dark circle and the reference skin color information from the corresponding designated positions. Thus, the image capture apparatus 1 is allowed to acquire the color information about the dark circle and the reference skin color information more simply.

The dark circle correction map generation unit 55 generates the correction information (dark circle correction map) based on the color information about the dark circle and the reference skin color information in HSV color space. The image composition unit 56 executes processing of correcting the dark circle under the human eye in the image in YUV color space by using the generated correction information (dark circle correction map). Thus, the image capture apparatus 1 is allowed to remove the dark circle while eliminating a feeling of strangeness.

The dark circle correction map generation unit 55 generates the correction information (dark circle correction map) to be used for correction by generating correction information (hue map) containing a candidate region for a dark circle region under the human eye in the image based on the acquired color information about the dark circle and the acquired reference skin color information in the image, and by correcting position information in an image of the generated correction information (hue map) containing the candidate region while using reference dark circle region information prepared in advance as position information in the image. By the combined use of the position information, the image capture apparatus 1 is allowed to remove a region such as a region in a similar color to the dark circle to be shaded by application of a light beam and difficult to distinguish from the dark circle only by the use of the color information, thereby allowing correction to a more precise position.

The image composition unit 56 executes processing of correcting a color indicated by the acquired color information about the dark circle so as to approximate the color to a color indicated by the acquired reference skin color information. This allows the image capture apparatus 1 to remove the dark circle while eliminating a feeling of strangeness.

The dark circle correction map generation unit 55 generates correction information (dark circle correction map) to be used for correcting a dark circle under a human eye in an image and indicating a position for correction in the image and a correction magnitude based on color information in HSV color space. The image composition unit 56 executes processing of correcting the dark circle under the human eye in the image based on color information in YUV color space by using the generated correction information (dark circle correction map). As described above, the image capture apparatus 1 generates a mask in HSV color space and makes correction in YUV color space by using the generated mask. In this way, the image capture apparatus 1 uses color information in appropriate color space for each of the processing of generating the correction information (dark circle correction map) and the correction processing, so that the dark circle can be corrected appropriately. As a result, the image capture apparatus 1 is allowed to correct the dark circle under the human eye appropriately by using the simple method.

The dark circle correction map generation unit 55 determines information about a V component of HSV color space as a main component, determines information about an H component and information about an S component of HSV color space as secondary components, and generates the correction information (dark circle correction map) indicating the position for correction in the image and the correction magnitude. The image composition unit 56 executes the processing of correcting the dark circle under the human eye in the image by using the generated correction information while determining information about a Y component of YUV color space as a main component and determining information about a U component and information about a V component of YUV color space as secondary components. As described above, the image capture apparatus 1 determines a component to react sensitively with a human eye as the main component, so that the dark circle can be corrected while eliminating a feeling of strangeness more effectively.

The dark circle correction map generation unit 55 generates the correction information (dark circle correction map) to be used for correction by generating correction information (hue map) containing a candidate region for a dark circle region under the human eye in the image while determining the information about the V component of HSV color space as the main component and determining the information about the H component and the information about the S component of HSV color space as the secondary components, and by correcting position information in an image of the generated correction information containing the candidate region while using reference dark circle region information prepared in advance as position information in the image. By the combined use of the position information, the image capture apparatus 1 is allowed to remove a region such as a region in a similar color to the dark circle to be shaded by application of a light beam and difficult to distinguish from the dark circle only by the use of the color information, thereby allowing correction to a more precise position.

The dark circle correction map generation unit 55 generates the correction information (dark circle correction map) by using color information about the dark circle and reference skin color information in HSV color space acquired based on the position of the detected human eye or that of the detected human pupil in the image. Thus, the image capture apparatus 1 is allowed to remove the dark circle while eliminating a feeling of strangeness.

The image composition unit 56 executes processing of correcting a color indicated by color information about the dark circle in YUV color space so as to approximate the color to a color indicated by reference skin color information in YUV color space by using the color information about the dark circle in YUV color space and the reference skin color information in YUV color space acquired based on the position of the detected human eye or that of the detected human pupil in the image. Thus, the image capture apparatus 1 is allowed to remove the dark circle while eliminating a feeling of strangeness.

The image capture apparatus 1 includes the dark circle correction map generation unit 55 and the image composition unit 56. The dark circle correction map generation unit 55 designates a candidate region for a dark circle region under a human eye in an image based on color information acquired from the image. The dark circle correction map generation unit 55 designates the dark circle region under the human eye in the image by correcting position information in an image of the candidate region designated by the dark circle correction map generation unit 55 while using reference dark circle region information prepared in advance containing position information in the image. The image composition unit 56 executes processing of correcting the color of the dark circle region designated by the dark circle correction map generation unit 55. As described above, the image capture apparatus 1 designates the candidate for the dark circle region based the color information. The image capture apparatus 1 uses a reference fixed map in combination to remove a region such as a region in a similar color to a dark circle to be shaded by application of a light beam and difficult to distinguish from the dark circle only by the use of the color information. In this way, the image capture apparatus 1 uses the reference dark circle region information for correcting the candidate for the dark circle region responsive to individual differences or conditions of image capture. Thus, the image capture apparatus 1 is allowed to appropriately correct the region difficult to distinguish from the dark circle, so that the dark circle can be corrected appropriately. As a result, the image capture apparatus 1 is allowed to correct the dark circle under the human eye appropriately by using the simple method.

The dark circle correction map generation unit 55 designates the candidate region by using color information about a dark circle and reference skin color information acquired based on the position of the human eye or that of the human pupil in the image detected by the pupil detection unit 52. Thus, the image capture apparatus 1 is allowed to designate the candidate region for correction more simply.

The image composition unit 56 executes processing of correcting a color indicated by the acquired color information about the dark circle so as to approximate the color to a color indicated by the acquired reference skin color information by using correction information (dark circle correction map) indicating a position for correction in the image and a correction magnitude. Thus, the image capture apparatus 1 is allowed to remove the dark circle while eliminating a feeling of strangeness.

The dark circle correction map generation unit 55 designates the candidate region based on color information in HSV color space. The dark circle correction map generation unit 55 designates the dark circle region under the human eye in the image based on the color information in HSV color space by correcting the designated candidate region while using the dark circle region information. The image composition unit 56 executes processing of correcting the designated dark circle region based on color information in YUV color space. This allows the image capture apparatus 1 to remove a dark circle while eliminating a feeling of strangeness more effectively.

It should be noted that the present invention is not to be limited to the aforementioned embodiment but modifications, improvements, etc. within a scope that can achieve the object of the present invention are included in the present invention.

In the above-described embodiment, the pupil of a human eye is detected for generation of the dark circle correction map. However, simply detecting the human eye may be sufficient. In this case, angle adjustment in the fixed map is omitted.

According to the above-described embodiment, image processing for dark circle correction may also be executed for each pixel by using correction information containing position information and magnitude information.

According to the above-described embodiment, an image for recording acquired by image capture by the image capture unit 16 is a processing target. Alternatively, the processing target may be an image stored in the image storage unit 71 or a live view image.

According to the above-described embodiment, a pixel constituting an image used for generation of a map may be pixels of a number corresponding to an image size for recording, or may be pixels thinned for display of a live view.

According to the above-described embodiment, a digital camera is shown as an example of the image capture apparatus 1 to which the present invention is applied. However, the image capture apparatus 1 is not particularly limited to a digital camera. For example, the present invention is applicable to common electronic devices having the function of the dark circle corrected image generation processing. More specifically, for example, the present invention is applicable to notebook personal computers, printers, television receivers, video cameras, portable navigation devices, portable telephones, smartphones, handheld game consoles, etc.

The above-described processing sequence can be executed by hardware or by software. In other words, the functional configuration shown in FIG. 6 is merely an illustrative example, and the present invention is not particularly limited to this configuration. Specifically, as long as the image capture apparatus 1 has a function enabling the above-described processing sequence to be executed in its entirety, the types of functional blocks employed to realize this function are not particularly limited to the example shown in FIG. 6. In addition, a single functional block may be configured by a hardware unit, by a software unit, or by combination of the hardware and software units. The functional configuration according to the present embodiment is realized by a processor to execute arithmetic processing. The processor applicable to the present invention includes processors formed of various processing units such as a single processor, a multiprocessor, and a multi-core processor, and processors formed of combinations between these processing units and processing circuits such as an application specific integrated circuit (ASIC) and a field-programmable gate array, for example.

If the processing sequence is to be executed by software, a program configuring the software is installed from a network or a storage medium into a computer, for example. The computer may be a computer embedded in dedicated hardware. Alternatively, the computer may be a general-purpose personal computer, for example, capable of executing various functions by means of installation of various programs.

The storage medium containing such programs can not only be constituted by the removable medium 31 shown in FIG. 1 distributed separately from an apparatus body in order to supply the programs to a user, but can also be constituted by a storage medium or the like supplied to the user in a state of being incorporated in the apparatus body in advance. The removable medium 31 is for example formed of a magnetic disk (including a floppy disk), an optical disk, or a magneto-optical disk. The optical disk is for example formed of a compact disk read-only memory (CD-ROM), a digital versatile disk (DVD), or a Blu-ray (registered trademark) Disk (Blu-ray Disk). The magneto-optical disk is for example formed of a Mini-Disk (MD). The storage medium, which is supplied to the user in a state of being incorporated in the apparatus body in advance, is for example formed of the ROM 12 shown in FIG. 1 storing a program or a hard disk included in the storage unit 19 shown in FIG. 1.

It should be noted that, in the present specification, the steps describing the program stored in the storage medium include not only processes executed in a time-series manner according to the order of the steps, but also processes executed in parallel or individually and not always required to be executed in a time-series manner.

While some embodiments of the present invention have been described above, these embodiments are merely exemplifications, and are not to limit the technical scope of the present invention. Various other embodiments can be employed for the present invention, and various modifications such as omissions and replacements are applicable without departing from the substance of the present invention. Such embodiments and modifications are included in the scope of the invention and the summary described in the present specification, and are included in the invention recited in the claims as well as in the equivalent scope thereof.

What is claimed is:

1. An image processing method for correcting a dark circle in an image, the method comprising:
detection processing of detecting a human eye in the image;
correction information generation processing of generating correction information indicating a position for correction in the image and a correction magnitude, by acquiring color information about the dark circle and reference skin color information in the image based on the position of the human eye in the image detected by the detection processing; and
image processing of executing processing of correcting the dark circle in the image by using the correction information generated by the correction information generation processing.

2. The image processing method according to claim 1, wherein in the correction information generation processing, positions below the position of the detected human eye in the image are designated as a position in the image where the color information about the dark circle is to be acquired and as a position in the image where the reference skin color information is to be acquired, and the color information about the dark circle and the reference skin color information are acquired from the corresponding designated positions.

3. The image processing method according to claim 1, wherein in the correction information generation processing, the correction information is generated based on the color information about the dark circle and the reference skin color information in HSV color space, and
in the image processing, processing of correcting the dark circle in the image is executed in YUV color space by using the generated correction information.

4. The image processing method according to claim 1, wherein in the correction information generation processing, the correction information to be used for correction is generated by generating a candidate for the correction information containing a candidate region for a dark circle region in the image based on the acquired color information about the dark circle and the acquired reference skin color information in the image, and by correcting position information in an image of the generated candidate for the correction information containing the candidate region while using reference dark circle region information prepared in advance as position information in the image.

5. The image processing method according to claim 1, wherein in the image processing, processing of correcting a color indicated by the acquired color information about the dark circle is executed so as to approximate the color to a color indicated by the acquired reference skin color information.

6. An image processing method for correcting a dark circle in an image, the method comprising:
correction information generation processing of generating correction information based on color information in HSV color space, to be used for correcting the dark circle in the image, and wherein the correction information indicates a position for correction in the image and a correction magnitude; and
image processing of executing processing of correcting the dark circle in the image based on color information in YUV color space by using the correction information generated by the correction information generation processing.

7. The image processing method according to claim 6, wherein in the correction information generation processing, information about a V component of HSV color space is determined as a main component, information about an H component and information about an S component of HSV color space are determined as secondary components, and the correction information is generated indicating the position for correction in the image and the correction magnitude, and
in the image processing, processing of correcting the dark circle in the image is executed by using the generated correction information while determining information about a Y component of YUV color space as a main component and determining information about a U component and information about a V component of YUV color space as secondary components.

8. The image processing method according to claim 7, wherein in the correction information generation processing, the correction information to be used for correction is generated by generating a candidate for the correction information containing a candidate region for a dark circle region in the image while determining the information about the V component of HSV color space as the main component and determining the information about the H component and the information about the S component of HSV color space as the secondary components, and by correcting position information in an image of the candidate for the correction information containing the candidate region while using reference dark circle region information prepared in advance as position information in the image.

9. The image processing method according to claim 6, further comprising detection processing of detecting the human eye in the image, wherein
in the correction information generation processing, the correction information is generated by using color information about the dark circle and reference skin color information in HSV color space acquired based on the position of the human eye in the image detected by the detection processing.

10. The image processing method according to claim 9, wherein in the image processing, processing of correcting a color indicated by color information about the dark circle in YUV color space is executed so as to approximate the color to a color indicated by reference skin color information in YUV color space by using the color information about the dark circle in YUV color space and the reference skin color information in YUV color space acquired based on the position of the detected human eye in the image.

11. An image processing method for correcting a dark circle in an image, the method comprising:
candidate region designation processing of designating a candidate region for a dark circle region in the image based on color information acquired from the image;
dark circle region designation processing of designating the dark circle region in the image by correcting position information in an image of the candidate region designated by the candidate region designation processing while using reference dark circle region information prepared in advance containing position information in the image; and
image processing of executing processing of correcting the color of the dark circle region designated by the dark circle region designation processing.

12. The image processing method according to claim 11, further comprising detection processing of detecting a human eye in the image, wherein
in the candidate region designation processing, the candidate region is designated by using color information about the dark circle and reference skin color information in the image acquired based on the position of the human eye in the image detected by the detection processing.

13. The image processing method according to claim 12, wherein in the image processing, processing of correcting a color indicated by the acquired color information about the dark circle is executed so as to approximate the color to a color indicated by the acquired reference skin color information by using correction information indicating the designated dark circle region in the image and a correction magnitude.

14. The image processing method according to claim 11, wherein in the candidate region designation processing, the candidate region is designated based on color information in HSV color space,
in the dark circle region designation processing, the dark circle region in the image is designated based on the color information in HSV color space by correcting the designated candidate region while using the dark circle region information, and
in the image processing, processing of correcting the color of the designated dark circle region is executed based on color information in YUV color space.

15. An image processing apparatus correcting a dark circle in an image,
the apparatus comprising a processor that is configured to:
detect a human eye in the image;
generate correction information indicating a position for correction in the image and a correction magnitude by acquiring color information about the dark circle and reference skin color information in the image based on the position of the detected human eye in the image; and
execute processing of correcting the dark circle in the image by using the generated correction information.

16. The image processing apparatus according to claim 15, wherein the processor is configured to designate positions below the position of the detected human eye in the image as a position in the image where the color information about the dark circle is to be acquired and as a position in the image where the reference skin color information is to be acquired, and to acquire the color information about the dark circle and the reference skin color information from the corresponding designated positions.

17. An image processing apparatus correcting a dark circle in an image,
the apparatus comprising a processor that is configured to:
generate correction information based on color information in HSV color space, to be used for correcting the dark circle in the image, and wherein the correction information indicates a position for correction in the image and a correction magnitude; and
execute processing of correcting the dark circle in the image based on color information in YUV color space by using the generated correction information.

18. The image processing apparatus according to claim 17, wherein the processor is configured to:
determine information about a V component of HSV color space as a main component, determine information about an H component and information about an S component of HSV color space as secondary components, and generate the correction information indicating the position for correction in the image and the correction magnitude; and
execute processing of correcting the dark circle in the image by using the generated correction information while determining information about a Y component of YUV color space as a main component and determining information about a U component and information about a V component of YUV color space as secondary components.

19. An image processing apparatus correcting a dark circle in an image,
the apparatus comprising a processor that is configured to:
designate a candidate region for a dark circle region in the image based on color information acquired from the image;
designate the dark circle region in the image by correcting position information in an image of the designated candidate region while using reference dark circle region information prepared in advance containing position information in the image; and
execute processing of correcting the color of the designated dark circle region.

20. The image processing apparatus according to claim 19, wherein the processor is further configured to:
detect a human eye in the image; and
designate the candidate region by using color information about the dark circle and reference skin color information in the image acquired based on the position of the detected human eye in the image.
